(19) United States
(12) Patent Application Publication
(10) Pub. No.: US 2023/0165273 A1
(43) Pub. Date: Jun. 1, 2023

(54) PET TREAT AND METHOD OF MAKING A PET TREAT

(71) Applicant: BOW WOW LABS, INC, Novato, CA (US)

(72) Inventor: Johnna Alison DEVEREAUX, Richmond, RI (US)

(21) Appl. No.: 17/922,765

(22) PCT Filed: May 7, 2021
(86) PCT No.: PCT/US21/31284

§ 371 Date: Nov. 1, 2022

Related U.S. Application Data
(60) Provisional application No. 63/021,978, filed on May 8, 2020.

(51) Int. Cl. A23K 10/26; A23K 40/00; A23K 50/42

(52) U.S. Cl. CPC A23K 10/26; A23K 40/00; A23K 50/42

(57) ABSTRACT

Here is described a method for the preparation of a proteinaceous treat. The method comprises comminuting a proteinaceous animal part into a plurality of pieces, each piece having a first volume; and increasing the volume of at least one piece to a second volume by heating the piece before cooling to ambient temperature.

This application claims benefit under 35 U.S.C § 119(e) of the U.S. Provisional Patent Application No. 63/021,978, filed May 8, 2020, the contents of which are incorporated by reference herein in its entirety.

### FIELD OF THE INVENTION

This invention relates to a pet treat and methods for the preparation of a pet treat. More particularly, to a method of making a proteinaceous pet treat having a puffed and crunchy consistency.

### BACKGROUND

There is a myriad of pet treats available for pet owners from which to choose. These include biscuits, soft treats, dental treats, rawhide and jerky. Treats can be made using animal parts or starchy materials.

Although treats are not specifically directed to be nutritionally valuable, starch and carbohydrates provide much less nutritional value than animal based products. Additionally, pets, such as cats and dogs, generally prefer treats that are meat based or at least meat flavored. Accordingly, starch based treats require additives for flavoring to make them enticing to pets.

Treats made from animal bi-products are common, since these are low in cost and generally high in protein. The parts can include ears, snout, skin, hooves, hide and pizzle. Unprocessed, these treats are susceptible to rapid spoiling due to bacterial growth. Processing usually requires greatly reducing the water content which can lead to highly dense, brittle and tough materials that are difficult to chew and can present a choking hazard or potential for intestinal obstruction to the pet.

There is, therefore, a need for improved protein based pet treats that are easy, enjoyable and safe for a pet to consume. This present disclosure is directed to providing such a pet treat.

### SUMMARY

In general, the description herein relates to pet treats and methods for the preparation of a pet treat. The methods, according to some implementations of the present disclosure, provide protein rich treats that are puffed and crunchy.

According to some implementations of the present disclosure, a method for the preparation of a proteinaceous treat. The method comprises comminuting a proteinaceous animal part into a plurality of pieces, each piece having a first volume. The method further comprising increasing the volume of at least one piece to a second volume by heating the piece before cooling to ambient temperature. Optionally, the method comprises placing, at least, one piece in an oven set at a temperature of more than 250° F. (121° C.) and less than 550° F. (288° C.) for a total time of heating less than 20 minutes and more than 5 minutes. Optionally, the oven is set at a temperature of more than 300° F. (149° C.) and less than 500° F. (260° C.) and the total time of heating is less than about 15 min and more than about 7 min.

According to some implementations of the present disclosure, is a proteinaceous treat according to any of the methods described herein.

The methods and products as disclosed herein provide a protein based treat that is safe and enjoyable for a pet to consume. In addition, the treats are based on a single animal part ingredient without need of additional ingredients, although additionally ingredients can be added.

### BRIEF DESCRIPTION OF THE FIGURES

This patent or application file contains at least one drawing executed in color. Copies of this patent or patent application publication with color drawing(s) will be provided by the Office upon request and payment of the necessary fee.

FIG. 1 illustrates pieces of an animal part processed according to some aspects of the present disclosure.

FIG. 2 is another illustration of the pieces similar to those shown in FIG. 1 in a different orientation.

FIG. 3 illustrates treats made according to some aspects of the present disclosure.

### DETAILED DESCRIPTION

Many different pet treats are available. Some of these treats comprise carbohydrate or starchy materials such as derived from flour, seeds and various types of grains. These treats also include ingredients such as humectants, flavorings and nutraceuticals. Where these treats are easy and enjoyable for pets to consume, they have very little nutritional value beyond any added nutrients and can, therefor, lead to overeating and weight gain. Other treats are based on animal parts and are typically dried to provide an extended shelf life. Where these treats can be more nutritious, they can be harder to chew and digest and even present a choking hazard, or expand in the stomach causing other discomforts to the pet. For example, beef pizzle (or the penis of a bull) is typically soaked, stretched and dried to render a tough chewy material. Some portions near the end of the pizzle can be large and thick and are often discarded by owners in order to avoid a pet choking on these parts.

The present disclosure relates to methods of preparing a proteinaceous treat to overcome some of the shortcoming identified above. The method comprises comminuting a proteinaceous animal part into a plurality of pieces, each piece having a first volume, and expanding the volume by heating the pieces. This provides a puffed treat that is crunchy throughout and easy for pets to consume. The method is easy to execute, needing only a single ingredient of a single animal part according to some aspects of the present disclosure. Since the treats are protein based, they are enticing to animals such as dogs and cats without additional ingredients or with minimal additional ingredients. There is also an added benefit to some pet owners who can experience satisfaction in a pet enjoying a crunchy treat.

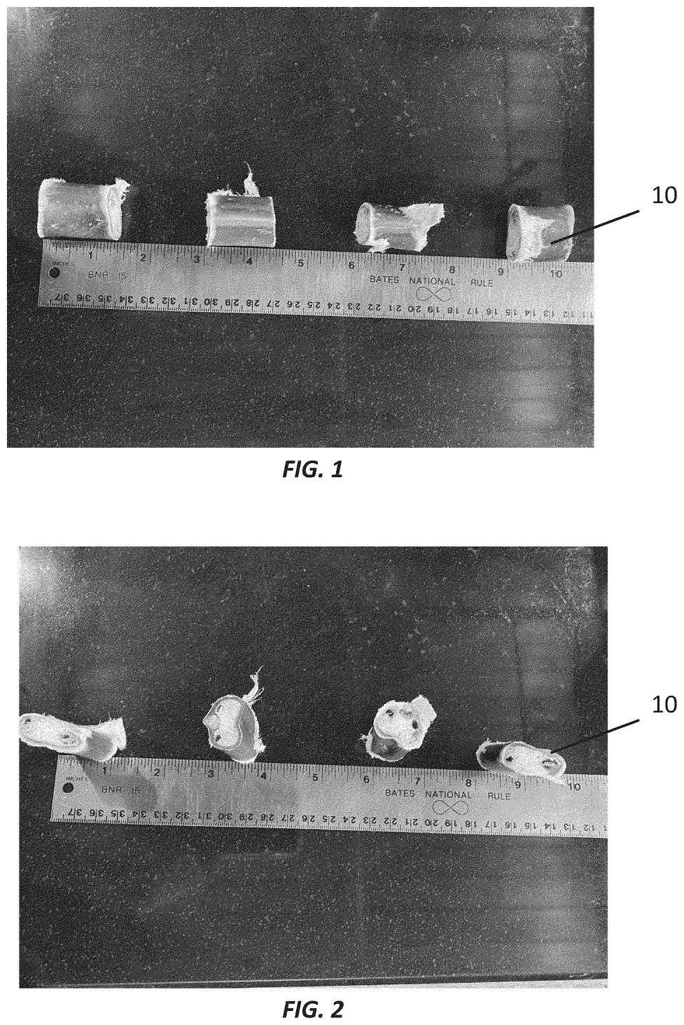

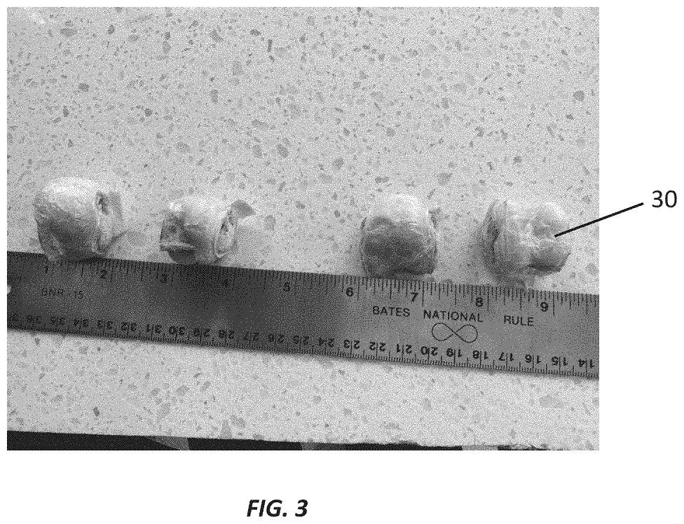

According to some aspects of the present disclosure, a proteinaceous animal part is comminuted into a plurality of pieces. The volume of these pieces are increase by a heating treatment followed by cooling back to an ambient temperature. As used herein, “pillowing” refers to this expansion, and the “pillowed” “pillowy” or “puffed” treat refers to the expanded look of these treats. This can also refer to the internal texture which is porous and of lower density than the initial starting pieces before the heat treatment. In addition, the treats have a crunchy consistency, wherein the hardness and fracture properties provide a brittle product that emits an audible crunch sound when chewed on by a pet. For example, contrasting with a chewy treat. FIG. 1 and FIG. 2 show the comminuted pieces 10 before heating according to some embodiments. FIG. 3 shows the puffed treat 30 after heating.

As used herein, “proteinaceous” refers to animal parts that have a high content of protein as opposed to parts such as bone. According to some aspects, the proteinaceous material comprises muscle meat. For example, including boneless muscle meat and fat.

According to some aspects of the present disclosure, the animal part is derived from a domesticated or farmed animal or venison. For example, and without limitation, according to some aspects any domesticated or farm animal include one or more of cows, buffalo, pigs, sheep, chickens, rabbit, and fish can be used to provide the animal part. According to some aspects, wild counterpart of a domesticated or farm animal can be used, such as wild pig, goats and fish. According to some aspects, the animal part is provided from, or without limitation, deer, elk, antelope, and hare.

According to some aspects of the present disclosure, the animal part is a neck, leg, or other appendage, pizzle, tongue, heart and other organs, or a portion thereof. According to some aspects, the animal part is a pizzle or a portion thereof, for example, a bull pizzle. According to some aspects, the animal part is not high in cartilage, such that the animal part includes less than about 10% cartilage. For example, according to some aspects the animal part is not an ear or snout.

According to some aspects, heating comprises placing, at least, one of a comminuted piece in an oven set at a temperature of more than 250° F. (121° F.) and less than 550° F. (288° C.) for a total time of heating less than 20 minutes and more than 5 minutes. According to some aspects, the oven is set at a temperature of more than 300° F. (149° C.) and less than 500° F. (260° C.) and the total time of heating is less than about 15 min and more than about 7 min. According some other aspects, the oven is set at temperature of about 450° F. (232° C.) and the total time of heating is about 13 minutes.

According to some aspects of the present disclosure, the oven is a convection oven, a conventional oven, air fryer, or a conveyor-belt oven (which might utilize cooking methods such as regular oven, convection oven, and/or a microwave process). According to some aspects, the oven is a convection or conventional oven, or a conveyor-belt oven configured as a convection or conventional oven. According to some aspects, the piece that has been heated is cooled under dry circulating air on a grid-type rack, such as a rack that can provide air circulation under the pieces. Without being bound by any specific theory, it is suggested that this drying provides a crunchy outside and inside by avoiding water condensation onto the piece as it cools.

According to some aspects, the treats are cooled to a temperature allowing for further processing, such as where the exterior temperatures is less than about 200° F. (e.g., less that about 150, 120, 100, 80, 50 or 35° F.). In some aspects cooling is for at least 1 min (e.g., 5, 10, 15, 20, 30 minutes). In some aspects cooling is for between about 15 and 25 min, such as 20 minutes.

According to some aspects of the present disclosure, the pieces are comminuted (e.g., cut or chopped) to provide pieces having a first volume defined by a cylinder having a length between about 0.56 inches to 4.50 inches (1.42 cm to 11.43 cm) and a radius between about 0.15 inches and 0.3 inches (0.38 cm to 0.77 cm). These pieces, subjected to heating as described herein, can provide a proteinaceous treat having a second volume defined by a cylinder having a length between 0.75 inches and 6 inches (1.90 cm to 15.24 cm) and a radius between about 0.25 inches and 0.75 inches (0.62 cm to 1.91 cm). For example, a pizzle having a radius of about 0.25 inch can be cut into pieces that are about 1 inch in length. According to some aspects, the first volume is less than about 21 cm³ (e.g., ≤20, ≤15, ≤10, ≤5, or ≤1 cm³). According to some aspects, the first volume is more than about 0.6 cm³ (e.g., ≥1, ≥2, ≥3 or ≥4 cm³). According to some aspects, the second volume is greater than about 2 cm³ (e.g., ≥3, ≥4, ≥5, ≥10, ≥15, ≥20, ≥25 cm³). According to some aspects, the second volume is less than about 200 cm³ (e.g., ≤, 195, ≤185, ≤175, ≤150, ≤100, ≤50, ≤45, ≤40, ≤35, or ≤30 cm³). According to some aspects, the second volume is at least 1 and ½ times the volume of the first volume, for example, the second volume is ≥2, ≥3, or ≥4 times the volume of the first volume.

According to some aspects of the present description, the mass of a piece before heating is more than about 50% greater than the mass of the piece after heating (e.g., >60%, 70%, 80% or 100%). According to some aspects, the moisture content is reduced by more than about 10% (e.g., more that about 20%, 30%, 40% or 50%) by the heating process. According some aspects, after heating and cooling, the treat has a density of between about 0.05 g/cm³ and about 0.4 g/cm³. For example, according to some aspects the density is about 0.1 to 0.3 g/cm³.

According to some further aspects of the present disclosure, a flavor is added to the treat. In some aspect, the flavor is added to the piece being processed during the heating. According to some aspects, the flavor is added after the piece begins to expand or puff out. According to some aspects, the flavor is added after a first stage of heating wherein said first stage of heating comprises at least 50% of a total time of heating (e.g., from time zero to 50% of the total time). For example, after 50%, after 60%, 70%, 80%, or 90% of the total heating time. According to some aspects, the flavor is added after a first stage of heating wherein said first stage of heating comprises at least 75% of a total time of heating. According to some aspects, the flavor is added after about 8 min (˜60%), about 9 min (˜70%), or about 10 min (˜75%), such as where a total heating time is 13 min (100%). According to some aspects, the flavor is added after the heating step and before the cooling step (e.g., at or after 13 min of a 13 min cook time). According to some aspects, the flavor is added at any time before the comminuted piece is cooled to room temperature.

As used herein, a “flavoring” or “flavor” is an ingredient or agent that is added to provide a taste and/or smell to treat and increase the appeal of the treat to the pet. According to some aspects of this disclosure, the flavoring can be in the form of a liquid (e.g., oil, aqueous or emulsion) a solid (e.g., a powder) or a paste (e.g., a mixture of power and liquid, a spreadable oil/fat). According to some aspects, the flavoring is a liquid. According to some aspects, the flavoring is added to the treat by basting (e.g., using an applicator such as a brush, or pouring onto the treat), immersing, spraying, spray drying, marinating, or enrobing. According to some aspects, the flavoring is added without removing the piece form the source of heat, while according to other aspects the piece is removed from the source of heat during the application, and then the piece is returned to the heating source to complete the heating process. According to some aspects, the addition of the flavoring is accomplished using an automated process, such as an emersion tank, a sheet of liquid poured on the pieces or a spray used in conjunction with a conveyor belt oven.

A flavor can be sourced from anywhere and can include poultry, beef, pork, seafood, and cheese flavors. For example, poultry flavors can include chicken broth flavor, chicken flavor, chicken liver flavor, or turkey flavor. Beef flavors can include, for example, beef jerky flavor, liver flavor, veal flavor. Pork flavors can include, for example, bacon flavor, ham flavor, and sausage flavor. Seafood flavors can include, for example, salmon flavor, tuna flavor, anchovy flavor, clam flavor, crab flavor and shrimp flavor. Cheese flavors can include, for example, cheddar, feta, limburger, gouda and provolone flavors and may be sourced from cow, goat, yak or other milk producing animal. According to some aspects of this disclosure the flavors are natural or artificial flavors.

According to some aspects of this disclosure, a nutrient is added to the treat. According to some aspects, the nutrient is added after the heating step. According to some aspects, the nutrient is added to the treat by basting (e.g., using an applicator such as a brush, or pouring onto the treat), immersing, spraying, spray drying, marinating, or enrobing. According to some aspects, the nutrient is added at any time before the comminuted piece is cooled to room temperature.

As used herein, a “nutrient” or “nutritional supplement” is an ingredient or agent that is added to provide a nutrition or nutritional supplementation to any nutrients already present in the treat. For example, some nutritional supplements are referred to or included in super foods. According to some aspects of this disclosure, the nutrient comprises a mineral, trace mineral, amino acids, a vitamin or a combination thereof. For example, minerals and trace minerals can include calcium, cobalt, copper, ferric or ferrous iron, magnesium, manganese, potassium, sodium and zinc. Vitamins can include, for example, Vitamin D, B1, B2, B6, B12. Vitamins can be supplied from various supplements and sources, for example, by cholecalciferol (supplies Vitamin D from animal sources), ergocalciferol (supplies Vitamin D from plant sources), riboflavin supplement (source of Vitamin B2), alpha-tocopherol acetate (Vitamin E), thiamine mononitrate (Vitamin B1), and pyridoxine hydrochloride (Vitamin B6). Amino acids can include, for example, DL-Methionine, L-Lysine, L-Threonine, DL-Tryptophan, taurine, DL-Arginine, and L-Tyrosine. According to some aspects, the nutrients are synthetic nutrients. In some other aspects, the nutrients are sources or derived from whole food nutrients. For example, whole food nutrients include, but are not limited to, spirulina, bee pollen, barley grass, alfalfa, berries (e.g. blueberries, cranberries, goji berries), and moringa powder.

According to some aspects of this disclosure, a preservative is added to the treat. For example, combined with and applied with the flavor, the nutrient or added separately before or after these e.g., during packaging. According to some aspects, the preservative is selected from ascorbic acid, benzoic acid, butylated hydroxyanisole, butylated hydroxytoluene, calcium ascorbate, citric acid, ethoxquin, potassium sorbate, sodium bisulfite, mixed tocopherols or combinations of two or more of these.

According to some aspects the flavors, nutrients or preservatives are selected as an approved ingredient from the Association of American Feed Control Officials' (AAFCO) Online Database of Ingredients (ODI) (e.g., www.aafco.org accessed May 6, 2020 and herein incorporated by reference). According to some embodiments the flavors, nutrients or preservatives are selected from ones Generally Recognized As Safe (GRAS) Under sections 201(s) and 409 of the Federal Food, Drug, and Cosmetic Act.

The treats, according to this disclosure, are suitable for animals. According to some aspects the treats are suitable for domesticated animals. According to some aspects, the treats are suitable for mammals. According to some aspects, the treats are suitable for carnivores. According to some aspects, the treats are suitable for cats and dogs. According to some aspects, the treats are suitable for dogs. According to some aspects, the treats are suitable for cats.

According to some aspects of this disclosure, the method further comprise packaging the treats. According to some aspects, the packaging can include single piece packaging or multi-piece packaging. According to some aspects, the packaging includes vacuum sealing one or more of the treats. According to some aspects, the packaging includes an oxygen-barrier bag.

According to some aspects, of the disclosure the methods described herein can be manual, semi-automated or fully automated. For example, a continuous process can be implemented wherein an animal part is (a) loaded onto a conveyor belt, (b) the animal part conveyed to a comminuting station to chop or slice the animal part into pieces. The comminuted parts can then be (c) conveyed through an oven wherein after a first stage of heating (d) a flavor is optionally added (e.g., spray or dip), the pieces are then conveyed out of the oven where (e) nutrients are optionally added (e.g., spray or dip). After cooling (f), for example using ambient dry air directed at the pieces, the pieces can be packaged at an automatic packaging stage. Any one or more of steps (a)-(f) can be done manually, to provide a semi-automated process. Where all the steps involve manual involvement, the process can be considered manual.

Embodiments of various aspects described herein can be defined as in any of the following numbered paragraphs:

1. A method for the preparation of a proteinaceous treat, the method comprising:
comminuting a proteinaceous animal part into a plurality of pieces, each piece having a first volume; and
   increasing the volume of at least one piece to a second volume by heating the piece before cooling to ambient temperature.
   2. The method according to paragraph 1, wherein heating comprises placing the piece in an oven set at a temperature of more than 250° F. (121° C.) and less than 550° F. (289° C.) for a total time of heating less than 20 minutes and more than 5 minutes.
   3. The method of paragraph 1 or 2, wherein the oven is set at a temperature of more than 300° F. (149° C.) and less than 500° F. (260° C.) and the total time of heating is less than about 15 min and more than about 7 min.
   4. The method of any one of the above paragraphs, wherein the piece is heated in the oven set at temperature of about 450° F. (232° C.) and the total time of heating is about 13 minutes.
   5. The method of any one of the above paragraphs, wherein the proteinaceous animal part is derived from a domesticated or farmed animal or venison.
   6. The method according to any one of the above paragraphs, wherein the proteinaceous animal part is a neck, leg or other appendage, pizzle, tongue, heart and other organs, or a portion thereof.
   7. The method of any one of the above paragraphs, wherein the proteinaceous animal part is muscle meat.
   8. The method of any one of the above paragraphs, wherein the proteinaceous animal part is a pizzle.
   9. The method of any one of the above paragraphs, wherein the proteinaceous animal part is not high in cartilage.
   10. The method of any one of the above paragraphs, wherein the oven is a convection oven, a conventional oven, air fryer or a conveyor-belt oven (which might utilize cooking methods such as regular oven, convection oven, and/or a microwave process).
   11. The method of any one of the above paragraphs, wherein said cooling is under dry circulating air on a grid-type rack or conveyor belt so it can form a crunchy outside.
   12. The method according to any one of the above paragraphs, further comprising adding a flavor to the piece during the heating.
   13. The method according to paragraph 12, wherein the flavor is added after a first stage of heating wherein said first stage of heating comprises at least 50% of a total time of heating.
   14. The method according to paragraph 13, wherein the first stage of heating comprises at least 75% of the total time of heating.
   15. The method according to any one of paragraphs 12-14, wherein the flavor is selected as an approved ingredient from the Association of American Feed Control Officials' (AAFCO) Online Database of Ingredients (ODI).
   16. The method according to any one of the above paragraphs, further comprising adding a nutrient to the piece after heating.
   17. The method according to paragraph 16, wherein the nutrient is added before the piece has cooled to ambient temperature.
   18. The method according to paragraph 16 or 17, wherein the nutrient comprises a mineral, amino acid, trace mineral, a vitamin or a combination thereof.
   19. The method according to any one of paragraphs 16-18, wherein the nutrient is selected from an approved ingredient from the Association of American Feed Control Officials' (AAFCO) Online Database of Ingredients (ODI).
   20. The method according to any one of the above paragraphs, wherein the first volume is less than about 21 cm³.
   21. The method according to any one of the above paragraphs, wherein the first volume is more than about 0.6 cm³.
   22. The method according to any one of the above paragraphs, wherein the second volume is greater than about 1 cm³.
   23. The method according to any one of the above paragraphs, wherein the second volume is less than about 200 cm³.
   24. The method according to any one of the above paragraphs, wherein the first volume is the volume defined by a cylinder having a length between about 0.56 inches to 4.50 inches (1.42 cm to 11.43 cm) and a radius between about 0.15 inches and 0.3 inches (0.38 cm to 0.77 cm), and the second volume is a volume defined by a cylinder having a length between 0.75 inches and 6 inches (1.90 cm to 15.24 cm) and a radius between about 0.25 inches and 0.75 inches (0.62 cm to 1.91 cm)).
   25. The method according to any one of the above paragraphs, wherein the second volume is at least 1 and ½ times the volume of the first volume (e.g., >2, >3, >4).
   26. The method according to any one of the above paragraphs, wherein the mass of the piece before heating is more than about 50% greater than the mass of the piece after heating (e.g., >60%, 70%, 80% or 100%).
   27. The method according to any one of the above paragraphs, wherein the treat has a density of between about 0.05 g/cm³ and about 0.4 g/cm³ after heating. (e.g., 0.1-0.3 g/cm³).
   28. A proteinaceous treat made according to the methods of any one of the above paragraphs.
   29. The proteinaceous treat according to paragraph 28, wherein the treat has a density between about 0.05 g/cm³ and about 0.4 g/cm³.
   30. The proteinaceous treat according to any one of paragraphs 28 or 29, wherein the treat comprises a single animal part.

The embodiments will be more readily understood by reference to the following examples, which are included merely for purposes of illustration of certain aspects and embodiments of the present invention, and should not be construed as limiting. As such, it will be readily apparent that any of the disclosed specific constructs and experimental plan can be substituted within the scope of the present disclosure.

### EXAMPLES

Optimization Experiments

The goal for these experiments was to find the cook (temperature & time) for protein (from any animal muscle such as beef, pork and chicken) where the natural fat is released and moisture from the protein evaporates—allowing the protein to expand to a “puffed” and “crunchy” consistency.

Initially, beef pizzle of a variety of sizes were placed in an oven at a low temperature of 200° F. (93° C.) and cooked for an extended time of 40 minutes. This resulted in an uneven cook of the pieces where the exterior exhibited expansion properties but the inside was scorched to a point of being burnt.

Realizing that one of the complexities was the non-uniformity of the pieces, the pizzle was cut into 1″ pieces. In an attempt to provide an even cook throughout, the oven temperature was increased to 250° F. (121° C.) while the time was decreased to 30 min. The results were unsatisfactory and similar as under the earlier conditions.

In a third attempt, the temperature was increased to 350° F. (177° C.) and reduce cook time to 20 minutes. This resulted in the exterior being burned and the interior core piece of protein being left intact with a chewy consistency.

Having so far not achieved the desired goals, more extreme conditions were tried. The experiments indicated that low temperatures and longer times were not suitable to cook the protein in a way where the expansion of the protein was consistent throughout and without burning. Accordingly, very high heat and short durations was decided as an extreme avenue for exploration. An attempt using 450° F. (232° C.) for 15 minutes, was surprising encouraging where it was found there were beginning signs of char on the exterior of the product, but the inner protein was at the desired consistency. Keeping the temperature at 450° F. (232° C.) and reducing the time to 10 min did not provide sufficient expansion of the protein for the ideal puffed treat.

Finally, optimal conditions for these 1″ pieces were found at 450° F. (232° C.) and 13 minutes of cook time. This provided a desirable end product with end product for a non-flavored puffed and crunchy pet treat. FIGS. 1 and 2 illustrate chopped pieces 10 of a bully stick prior to baking. FIG. 3 illustrates the chopped pieces 30 after the baking procedure.

The product was presented to a test subject dog who showed great interest and immediately and enthusiastically consumed the treat. The treat also provided an audible crunch which was satisfying at least to the pet care taker. A small piece that was broken off showed a puffed, pillowy and crunchy consistency throughout.

The steps for preparing the treats is outlined here

1. Preheat oven to 450 (232° C.) degrees (Frigidaire Gallery Model FGEW2765P).

2. Take either a 6- or 12-inch bully stick.

3. Cut stick into 1″ long pieces.

4. Place cut pieces onto an aluminized steel baking sheet spaced out with 2″ between pieces.

5. Place cooking sheet with pieces into the oven.

6. Cook for 13 minutes.

7. Remove from oven and immediately place on a grid-type cooling rack for 20 minutes.

8. Package in an air-tight, oxygen barrier bag

Flavored Version

The optimal conditions discovered above were modified to include additional flavoring. The flavor is infused into the treat to offer flavor variety. At 10 minutes in the above cooking process, enough protein expansion and pillowing has occurred to allow basting of specific ingredients/recipe onto the treats. Therefore, this is done as a step between 5 and 6 above. Completion of the cook for an additional three minutes' seals in the flavor without compromising the end product.

Nutrient Addition

In another modification, nutrients can be added. Since nutrients tend to degrade under the high temperature used, these should be added after the cooking stage. Adding this by basting and allowing cooling under good air circulation provides nutrient coating and infusion of the treats. For example, it is found that cooling on a rack allows the moisture added with the nutrients to absorb into the treat and the crunchy consistency is maintained.

Other Options

The above conditions were found to be idea for the size of animal part. Where smaller or larger pieces are used, the temperature and time can be modified.

The above conditions are also dependent on the kind of oven used. For example, when moving from a non-commercial oven as above to a commercial oven differences are expected. For example, a lower set temperature can be used.

As used herein, the term “comprising” or “comprises” is used in reference to compositions, methods, and respective component(s) thereof, that are essential to the claimed invention, yet open to the inclusion of unspecified elements, whether essential or not.

As used herein, the term “consisting essentially of” refers to those elements required for a given embodiment. The term permits the presence of elements that do not materially affect the basic and novel or functional characteristic(s) of that embodiment of the claimed invention.

The term “consisting of” refers to compositions, methods, and respective components thereof as described herein, which are exclusive of any element not recited in that description of the embodiment.

As used in this specification and the appended claims, the singular forms “a,” “an,” and “the” include plural references unless the context clearly dictates otherwise. Thus, for example, references to “the method” includes one or more methods, and/or steps of the type described herein and/or which will become apparent to those persons skilled in the art upon reading this disclosure and so forth.

All patents, patent applications, and publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

1-30. (canceled)

31. A method for the preparation of a proteinaceous treat, the method comprising:
comminuting a proteinaceous animal part into a plurality of pieces, each piece having a first volume; and
increasing the volume of at least one piece to a second volume by heating the piece before cooling to ambient temperature.

32. The method according to claim 31, wherein heating comprises placing the piece in an oven set at a temperature of more than 250° F. (121° C.) and less than 550° F. (289° C.) for a total time of heating less than 20 minutes and more than 5 minutes.

33. The method of claim 31, wherein the proteinaceous animal part is muscle meat.

34. The method of claim 31, wherein the proteinaceous animal part is a pizzle.

35. The method of claim 31, wherein the proteinaceous animal part is not high in cartilage.

36. The method of claim 31, wherein the oven is a convection oven, a conventional oven, air fryer or a conveyor-belt oven.

37. The method of claim 31, wherein said cooling is under dry circulating air on a grid-type rack so it can form a crunchy outside.

38. The method of claim 31, further comprising adding a flavor to the piece during the heating.

39. The method according to claim 38, wherein the flavor is added after a first stage of heating wherein said first stage of heating comprises at least 50% of a total time of heating.

40. The method according to claim 31, further comprising adding a nutrient to the piece after heating.

41. The method according to claim 40, wherein the nutrient is added before the piece has cooled to ambient temperature.

42. The method according to claim 31, wherein the first volume is less than about 21 cm³.

43. The method according to claim 31, wherein the first volume is more than about 0.6 cm³.

44. The method according to claim 31, wherein the second volume is less than about 200 cm³.

45. The method according to claim 31, wherein the first volume is the volume defined by a cylinder having a length between about 0.56 to 4.50 inches (1.42 to 11.43 cm) and a radius between about 0.15 and 0.3 inches (0.381 to 0.762 cm), and the second volume is a volume defined by a cylinder having a length between 0.75 and 6 inches (1.905 to 15.24 cm) and a radius between about 0.25 and 0.75 inches (0.625 to 1.905 cm).

46. The method according to claim 31, wherein the mass of the piece before heating is more than about 50% greater than the mass of the piece after heating.

47. The method according to claim 31, wherein the treat has a density of between about 0.05 g/cm³ and about 0.4 g/cm³ after heating. (e.g., 0.1-0.3 g/cm³).

48. A proteinaceous treat made according to the methods of claim 31.

49. The proteinaceous treat according to claim 48, wherein the treat has a density between about 0.05 g/cm³ and about 0.4 g/cm³.

50. The proteinaceous treat according to claim 48, wherein the treat comprises a single animal part.
